(19) United States
(12) Patent Application Publication
(10) Pub. No.: US 2003/0138122 A1
(43) Pub. Date: Jul. 24, 2003

(54) Sound-reproducing support

(76) Inventor: Alexander Vitalievich Smirnov, Moscow (RU)

Correspondence Address: A Smirnov, Y Vladagin, 6038 Tyndall Avenue, Bronx, NY, 10471, US

(21) Appl. No.: 10/297,863

(22) PCT Filed: Jul. 6, 2001
(86) PCT No.: PCT/RU01/00269

(30) Foreign Application Priority Data
Jul. 18, 2000 (RU) 2000119009

(51) Int. Cl. H04R 1/02; H04R 9/06

(52) U.S. Cl. 381/332

(57) ABSTRACT

The invention relates to radio-electronics, in particular to audible warning devices. In order to enlarge the functional possibilities, the inventive sound-reproduction support is provided with a sensor for measuring the weight of a vessel, a coding block, and an event detecting block arranged inside its housing.

### FIELD OF THE INVENTION

The invention relates to radio-electronics and more particularly to audible alarm system and audible advertising devices. It can be used in designing bottle, can and other vessels supports, providing the customer with information, as well as serving for advertising and entertainment.

### BACKGROUND OF THE INVENTION

U.S. Pat. No. 5,499,465 to Manico, 1996, discloses a device containing a block for reproducing audible messages with a loudspeaker, a power supply, and a switch displaced in the housing. The first bus of the power supply is connected with the first supply input of the block for reproducing audible messages.

The device according to Manico is a picture frame having a switch in the lower part of the housing. When the device is placed on the table, the switch is unlocked and audible messages are not reproduced. When the device is lifted up, the switch locks in, connecting the input of the reproduction activation with the first supply bus and a pre-recorded message is played back.

The limitation of the above device lies in its moderate functionality, since the message is reproduced only if the device is picked up from the table and does not depend on the weight of the vessel located on the support.

A sound reproducing support as disclosed in U.S. Pat. No. 5,489,893 to Jo, 1996, is most close to the claimed invention. The support according to Jo comprises a block for message reproduction with a loudspeaker, a power supply, and a switch located in the housing operative so that a vessel can be placed into it. The first power supply bus is connected with the first output of the block for message reproduction, and the second power supply bus is connected with the second supply input of the block for message reproduction via the switch.

The device according to Jo is a support used with a bottle. Audible messages are reproduced, when the bottle is inserted into the support. When the bottle is put back into the support, no messages are reproduced.

The limitation of the above device is its limited functionality. Messages are reproduced only when the vessel is inserted into the support and do not depend on the vessel weight displaced on the support, that is do not depend on the amount of the liquid in the bottle. Another limitation of the device is its inconvenience in use. As the support is not fixed to the bottle and each time the bottle is lifted it is taken out of the support, it has to be inserted back each time after its use. Besides, the switching of the power supply is made manually that is a separate action on the user part is required.

### OBJECTS AND SUMMARY OF THE INVENTION

It is an object of the present invention to provide an audio-reproducing support with enlarged functional capacities.

Another object of the present invention is to provide an audio-reproducing support with higher user convenience.

These and other objects of the present invention are achieved in the support the description of which is given below.

The sound-reproducing support according to the present invention comprises a housing made with a possibility to place a vessel onto it and displaced in said housing a message reproducing block with a loudspeaker, a vessel weight sensor, a coding block, an event detecting block, a switch, and a power supply connected via the switch to the message reproducing block, the vessel weight sensor, the coding block, and the event detecting block. The output of the vessel weight sensor is connected through the coding block to the first control input of the message reproducing block, the second control input of which is connected to the output of the event detecting block.

Further, the sound-reproducing support housing is equipped with an inner overlap serving as a surface for installing a vessel in the housing.

Further, the vessel weight sensor in the present invention sound-reproducing support is a strain sensor mounted on the housing.

Further, the vessel weight sensor of the sound-reproducing support comprises a fixed part mechanically connected to the housing and a mobile part connected to the housing via at least one elastic element and mounted so that the weight of the vessel installed into the housing is applied to the mobile part.

Further, the coding block of the sound-reproducing support comprises a control input connected to an additional output of the event detecting block.

Further, the event detecting block in the sound-reproducing support comprises a first, second, and third impulse formers. The inputs of the first and third impulse formers are connected to the input of the event detection block, which in its turn is connected to the vessel weight sensor output. The output of the first impulse former is an additional output of the event detecting block and connected via the second impulse former to an output of the event detecting block and to an output of the third impulse former.

Further, the event detecting block in the sound-reproducing support comprises a switch, a resistor, a first, second and third impulse formers. The switch is operative to unlock upon the placement of the support on the surface and to lock upon the removal of the support from the surface. The first supply input of the event detecting block via switch and second supply input via the resistor are connected to inputs of the first and third impulse formers. The output of said first impulse former is an additional output of the event detecting block and connected via the second impulse former to an output of the event detecting block and to an output of the third impulse former.

Moreover, the housing of the sound-reproducing support is implemented with a possibility to fix the vessel installed into it.

Further, the housing of the sound-reproducing support is equipped with a fixing ring out of an elastic material.

Further, the switch in the sound-reproducing support is operative to lock upon the placement of the vessel onto said housing.

The introduction of the vessel weight sensor, the coding block, and the events detecting block with corresponding connections provides the reproduction of various sound messages depending on the vessel weight mounted on the sound-reproducing support and on the user manipulations with the vessel. Thus, a wider device functionality is provided.

Furthermore, the peculiarities of the housing and the switch provide the possibility of fixing the vessel in the support and an automatic power supply connection and disconnection. Thus, the additional advantage of higher user convenience is achieved.

### BRIEF DESCRIPTION OF DRAWINGS

Further the invention will be illustrated by the accompanying drawings.

FIG. 1 shows a sound-reproducing support construction;

FIG. 2 shows an electrical structural circuit;

FIG. 3 shows another variant of the support construction;

FIG. 4 shows an electrical structural circuit of the coding block and a circuit of one of the variants of an event detecting block;

FIG. 5 shows an electrical structural circuit of another variant of the event detecting block;

FIG. 6 shows a fragment of the structure of one of the variants of the vessel weight sensor;

FIG. 7 shows an electric structural circuit of a variant of the vessel weight sensor;

FIG. 8 shows a flow-chart of a program run by the message reproducing block

### THE PREFERRED EMBODIMENTS OF THE INVENTION

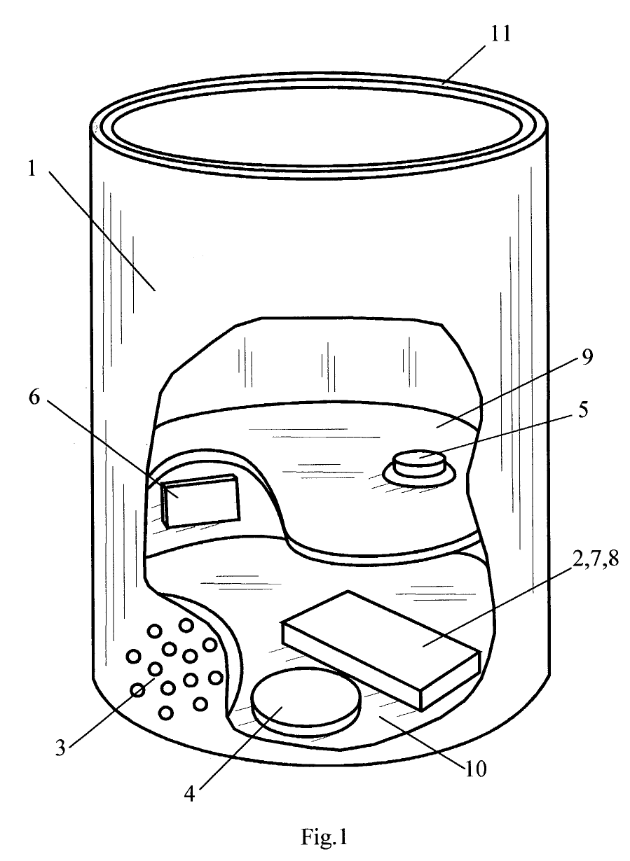

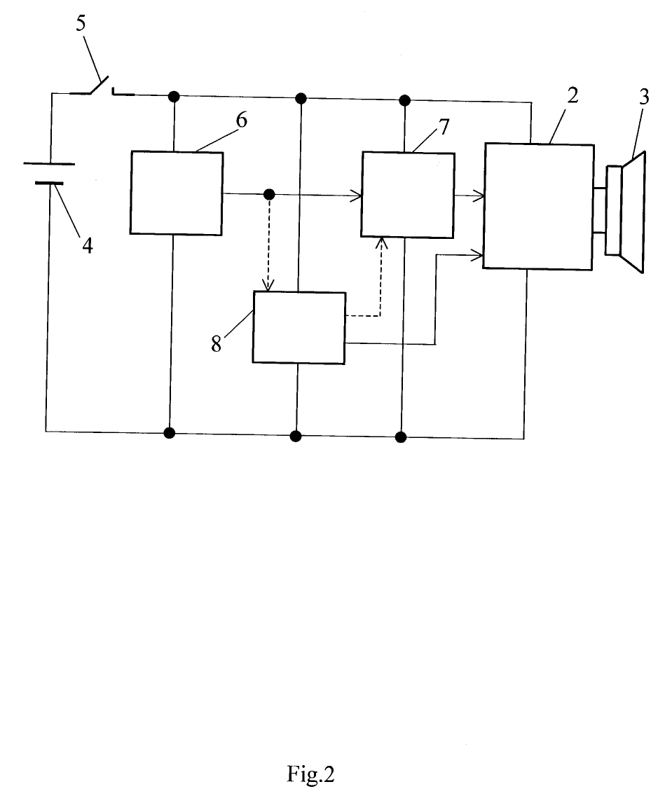

An audio reproducing support (FIGS. 1 and 2) comprises housing 1, which has message reproducing block 2 with loudspeaker 3, power supply 4, switch 5, vessel weight sensor 6, coding block 7, and event detecting block 8.

The first power supply 4 bus is connected with the first outputs of message reproducing block 2, vessel weight sensor 6, coding block 7, and of event detecting block 8. The second supply 4 bus is connected via switch 5 with the second supply inputs of message reproducing block 2, vessel weight sensor 6, coding block 7, and event detecting block 8. Vessel weight sensor 6 output is connected via coding block 7 with the first control input of message reproducing block 2, the second control input of which is connected with the output bus of event detecting block 8. The outputs of message reproducing block 2 are connected with loudspeaker 3.

Housing 1 is made so that a vessel can be inserted into it. For this purpose, it has an open upper end and inner overlap 9 in this inventive variant. Overlap 9 serves as a support for the vessel placed into housing 1. Housing 1 has also bottom end 10, which can be fixed to the rest part of housing 1 by screws, for example.

The vessel weight sensor may contain a strain sensor glued to the inner or outer surface of the side wall of housing 1. Constant resistors and an amplifier mounted in this variant in vessel weight sensor 6 may be constructively placed separately from the strain sensor.

Housing 1 may be embodied so that a vessel may be fixed within it. For this purpose, for example fixing ring 11 made of an elastic material can be installed in the upper part of housing 1.

Switch 5 may be displaced so that it locks when the vessel is being placed in housing 1. For example, switch 5 may be implemented as a button located on inner overlap 9.

Message reproducing block 2, coding block 7, and event detecting block 8 shown in FIG. 1 are constructively combined. Inner overlap 9 is shown with a cutting.

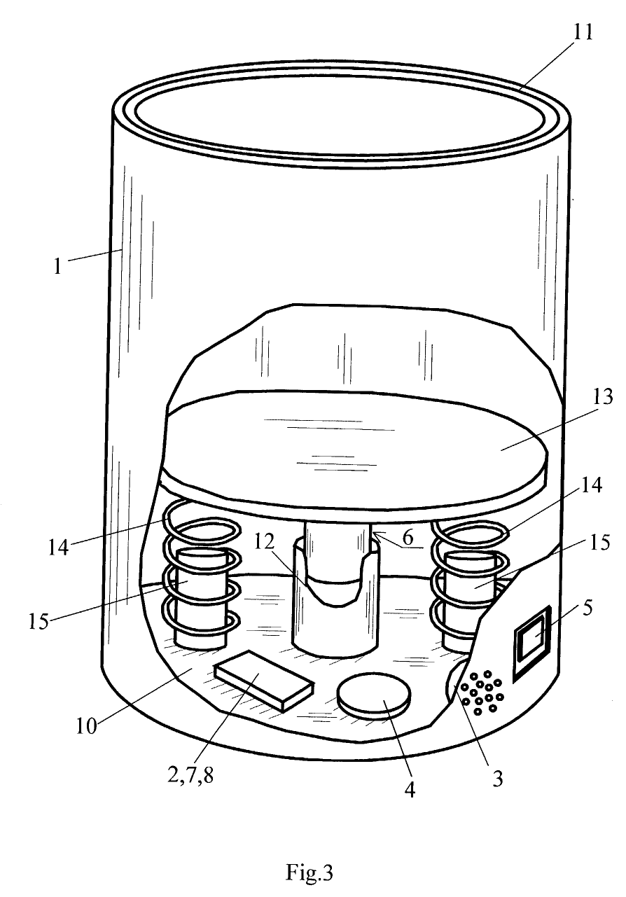

According to another inventive variant (FIG. 3), vessel weight sensor 6 may contain fixed part 12 and mobile part 13. Fixed part 12 is mechanically connected with housing 1. Mobile part 13 is mechanically connected with housing 1 by elastic elements 14 which may be embodied as springs and is displaced so that the weight of the vessel inserted into housing 1 is applied to it. The number of elastic elements 14 may be equal to N, wherein N is a whole integer. Bottom end 10 of housing 1 has posts 15, providing a fixed position of elastic elements 14. Switch 5 in this variant of the construction is implemented as a switch mounted in the side wall of housing 1. A detailed description of an example of vessel weight sensor 6 is given further.

Coding block 7 may be equipped with a control input which is connected with an additional output of event detecting block 8 (FIG. 2). In this case, coding block 7 may contain (FIG. 4) an analog-to-digital converter (ADC) 16 and register 17. The input of ADC 16 is connected to the input of coding block 7 and the output is connected to the input of register 17, clock input and output of which are connected to the control input and to the output bus of coding block 7, accordingly.

ADC 16 and register 17 may be implemented on standard integrated circuits (ICs), supply inputs of which are connected with the corresponding coding block 7 supply inputs (not shown in FIG. 4). The output bus of coding block 7, ADC 16 output, register 17 input and output contain K bits, where K is a number of used ADC 16 bits.

Event detecting block 8 (FIG. 4) may contain first, second and third impulse formers 18, 19 and 20. The inputs of first and third impulse formers 18, 20 are connected with the output of event detecting block 8 connected with vessel weight sensor 6 output. The first impulse former 18 output is an additional output of event detecting block 8 and connected via second impulse former 19 to event detecting block 8 output bus connected with third impulse former 20.

First, second and third impulse formers 18, 19, 20 may be embodied as monostable multivibrators. First former 18 generates impulses on the positive voltage fluctuation on its input. Second and third formers 19 and 20 generate impulses on the negative voltage fluctuation on their inputs. The output bus of event detecting block 8 contains the first and the second communication lines for transmitting impulses formed by second and third impulse formers 19 and 20 accordingly. The supply inputs of impulse formers 18, 19 and 20 are connected with the corresponding supply inputs of event detecting block 8 (not shown in FIG. 4).

According to another variant, event detecting block 8 may contain switch 21, resistor 22, first, second and third impulse formers 18, 19 and 20. The first supply input of event detecting block 8 via switch 21, and its second supply input via resistor22 are connected with the first and third impulse formers 18, 20 inputs. The first impulse former 18 output is an additional event detecting block 8 output and it is connected with event detecting block 8 output bus via second impulse former 19. The event detecting block 8 output bus is connected with the third impulse former 20 output.

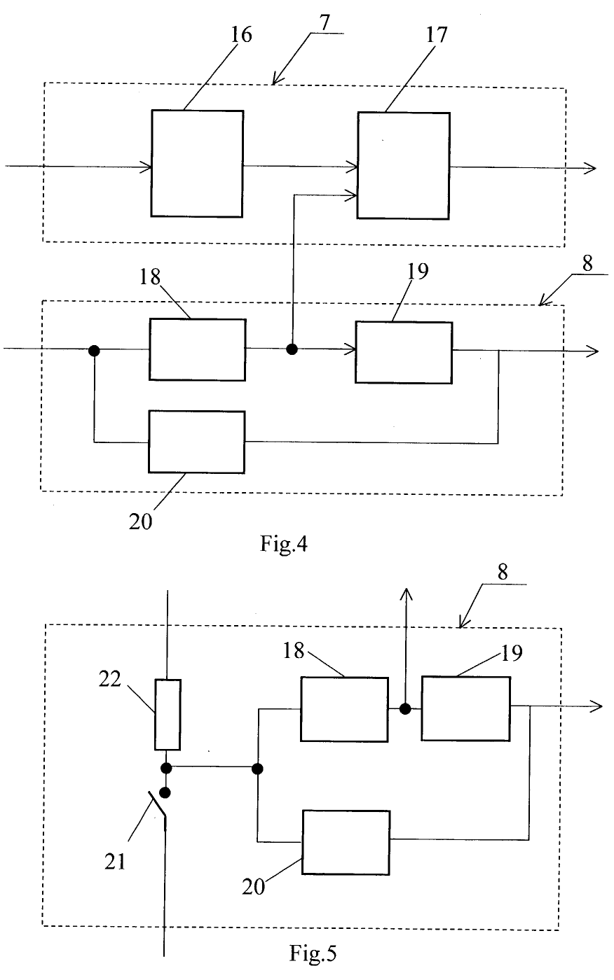

Switch 21 unlocks upon the placement of the support on the surface and locks upon the removal of the support. For example, a button may be mounted on bottom end 10 of housing 1 (not shown in FIG. 1 and FIG. 3). The embodiment of impulse formers 18, 19 and 20 may be the same as in the variant shown in FIG. 4. The impulse formers 18, 19 and 20 supply inputs are connected with the respective outputs of event detecting block 8 (not shown in FIG. 5)

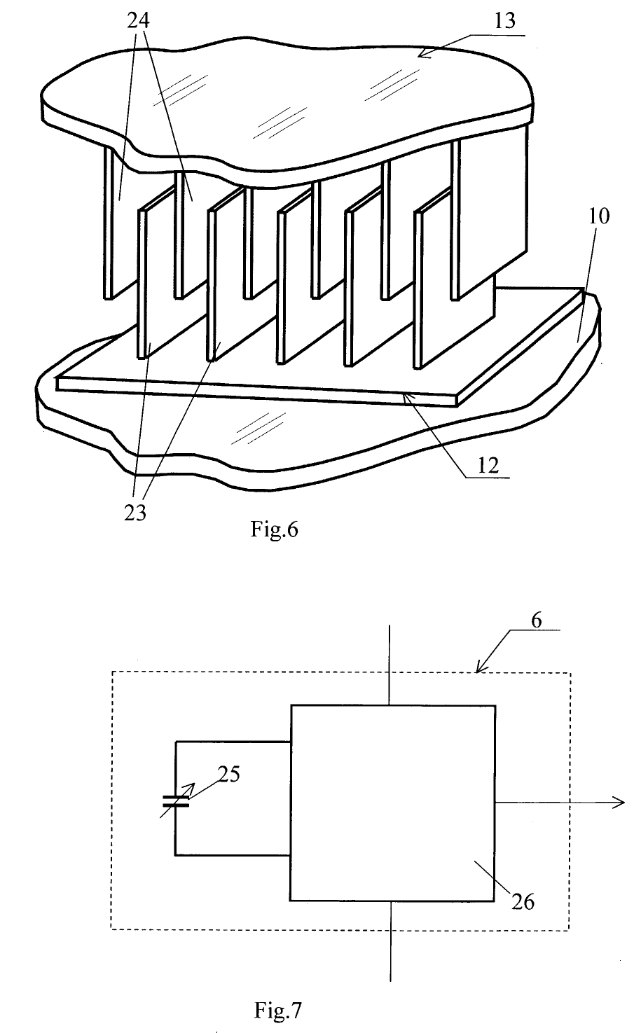

In one of the variants of vessel weight sensor 6 (FIG. 6), fixed part 12 contains first metallic plates 23 and mobile part 13 contains second metallic plates 24 mounted so that when mobile part 13 moves down, second metallic plates 24 move into the spaces between first metallic plates 23.

The structural electrical circuit of this variant of sensor 6 (FIG. 7) contains variable capacitor 25 and capacity-to-voltage converter 26. One variable capacitor 25 plate is formed by electrically connected first metallic plates 23 and the other plate is formed by electrically connected second metallic plates 24. Variable capacitor 25 plates are connected with the inputs of capacity-to-voltage converter 26, first and second supply inputs of which are connected with the first and second supply inputs of vessel weight control sensor 6 with its output connected to the output of capacity-to-voltage converter 26.

Capacity-to-voltage converter 26 may be implemented according to one of the well-known schemes. For instance, it may contain a generator of impulses of a preset frequency with an impulse length depending on the capacity of variable capacitor 25 and an integrator converting said impulses to voltage.

Vessel weight sensor 6 for the construction variant shown in FIG. 3 may also have other variants of its implementation.

For example, fixed part 12 may contain an induction coil, and mobile part 13 may contain a core of ferromagnetic material inserted into the induction coil upon the downward movement of mobile part 13. Vessel weight control sensor 6 has to contain, in this case, a inductance-to-voltage converter.

Fixed part 12 may contain a light-emitting diode and a photodiode with an amplifier. Mobile part 13 may contain a diaphragm with an aperture in a form of a vertical spike. The displacement of mobile part 13 in this case causes the change of the radiation stream on the photodiode, and consequently, of the voltage at the amplifier output.

Fixed part 12 may contain a variable resistor, and mobile part 13 may be mechanically connected with the contact arm of this variable resistor. At the dislocation of mobile part 13, the supply voltage on the mobile contact of the variable resistor will change.

Fixed part 12 may contain a group of contacts, vertically placed, and mobile part 13 may contain one contact, electrically connected with the second supply input of vessel weight sensor 6. At the dislocation of mobile part 13, its contact sequentially comes into contact with fixed part 12 contacts, in which the supply voltage appears sequentially. In this variant of its implementation, coding block 7 should contain, instead of ADC, a digital coder.

Message reproducing block 2 may be implemented on the base of a customized sound synthesizer integrated circuit, for instance W52910, W52915 or W52920, by Winbond Electronics Corp., Taiwan. Such ICs comprise means for the reproduction of prerecorded messages of 40, 60, and 80 seconds respectively.

The first and second supply inputs of message reproducing block 2 are the negative and positive supply inputs of the IC. An 8 bit input-output port of the sound synthesizer IC is used as the first control input of message reproducing block 2. The second control input of message reproducing block 2 has the first and second bits implemented as two out of four trigger inputs. On the voltage fluctuation on these inputs, the sound synthesizer IC gets out of the waiting mode and starts to run the corresponding program. The IC RESET input may be connected with its positive supply input.

Besides one of the above ICs, message reproducing block 2 comprises an amplifying transistor attached in accordance to the IC technical data sheet. The load circuit of the amplifying transistor includes loudspeaker 3, the active resistance of which should be 8 Ohm. Power supply 4 for the above ICs may contain from 2 to 4 miniature batteries.

Other variants of message reproducing block 2 are possible. For instance, it may contain a microprocessor and a ROM containing sound messages and a program run by the microprocessor.

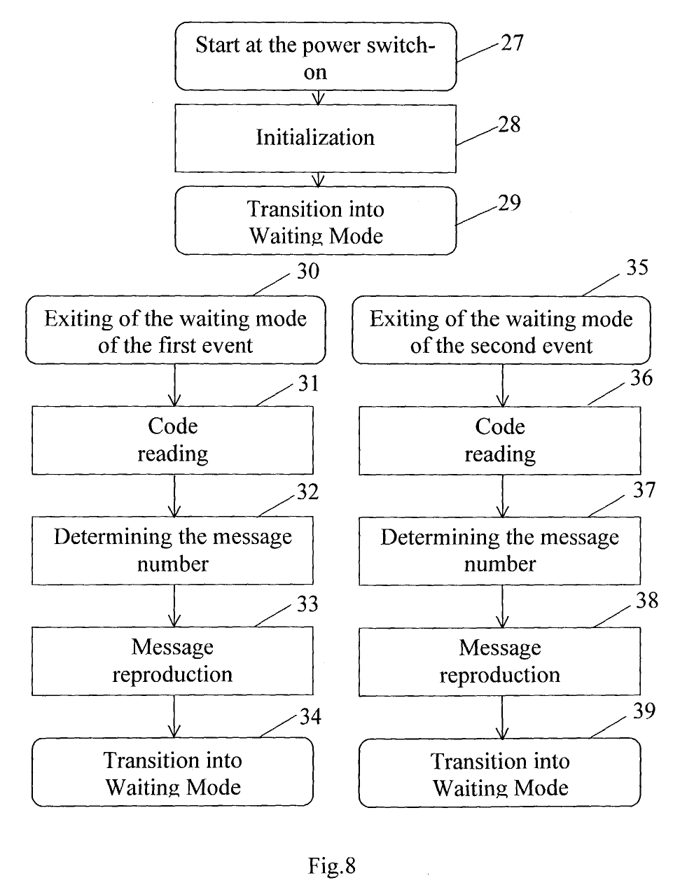

The flow-chart of the program (FIG. 8) run in message reproducing block 2 contains program-blocks 27 . . . 39.

### OPERATION OF THE DEVICE

A vessel, for example a bottle, is placed into housing 1 of the sound-reproducing support located on a surface, for example on a table. In the variant of the construction shown in FIG. 1, the vessel leans on inner overlap 9. This locks switch 5, and power supply 4 gets connected to vessel weight sensor 6, message reproducing block 2, coding block 7, and event detecting block 8. The vessel is fixed in housing 1 with the help of fixing ring 11. In the variant of the construction shown in FIG. 3, to activate power supply 4 switch 5 is locked manually.

The mechanical tension on the housing sides generated by the vessel weight activates vessel weigh sensor 6. (FIG. 1), and the voltage appears at the output of this sensor. The voltage value depends on the vessel weight. If vessel weight sensor 6 has a fixed part 12 and mobile part 13 (FIG. 3), then the voltage on its output is determined by the value of mobile part 13 displacement against its initial position, that is the position it occupied before the vessel was placed on the support. As the value of the above displacement is determined by the vessel weight and elasticity of elastic elements 14, the voltage on the output of sensor 6 in this case also depends on the weight of the vessel placed on the support. The voltage from the output of vessel weight sensor 6 arrives in coding block, wherein it is converted into the digital format with the help of ADC 16.

Event detecting block 8 responds to two types of events: lifting of the vessel together with the sound-reproducing support from the surface and placing the vessel with the sound-reproducing support on the surface.

In the variant shown in FIG. 4, event detecting block 8 responds to the voltage fluctuation at the output of vessel weight sensor 6. When the vessel is lifted, said voltage decreases, as the vessel weight stops affecting sensor 6. Third impulse former 20 activates, the impulse from its output arrives at the second bit of the second control input of message reproducing block 2 and calls the running of the program of reproducing a corresponding message. At this point, first former 18 does not activate. That is why the code recorded in register 17 and arriving at the first control input of message reproducing block 2 does not change.

When the vessel with the support is placed on the surface, the vessel weight is again applied to sensor 6, and the voltage at the output of sensor 6 increases. This activates first impulse former 18, at the output of which the impulse is formed with the length enough to fulfil analogue-to-digital conversion in ADC 16. According to the impulse falling edge at the output of first former 18 the code from the ADC 16 output is recorded into register 17. From the output of register 17 the code corresponding to the vessel weight arrives at the first control input of message reproducing block 2. At the same time, second former 19 activates and the impulse from its output arrives at the first bit of the second control input of message reproducing block 2 and calls the running of the program for reproducing of a corresponding message.

Thus, the code at the first control input of message reproducing block 2 corresponds to the vessel weight in both cases—when the vessel with the support is lifted from the surface and when the vessel with the support is placed on the surface. Impulses activating the sound reproduction in both above cases arrive correspondingly to the second and first bits of the second control input of message reproducing block 2.

If event detecting block 8 is implemented as in the variant shown in FIG. 5, switch 21 locks when the vessel with the support is lifted from the surface, and at the outputs of first and third impulse formers 18, 20 the negative voltage fluctuation is formed. When the vessel with the support is put down on the surface, switch 21 unlocks, and a positive voltage fluctuation is formed at the above outputs. The rest operation of the device is as described above.

Other variants of implementing event detecting block 8 are also possible. According to them, block 8 can respond to some other events, for example to an acceleration on the horizontal surface, to an inclination, to switching the light on and off, to sound signals, to radio-signals, etc.

If the fixing of the vessel in housing 1 is not implemented, the vessel is taken out of the support, when it is lifted up and is inserted back, when it is put back. In this case, the variant of event detecting block as shown in FIG. 4 can be used. Vessel weight sensor 6, coding block 7, and event detecting block 8 operate as in an earlier considered variant.

The program recorded in message reproducing block 2 begins to run, when the power is supplied (block 27). At the beginning the initialization takes place (block 28), during which according to the technical data sheet of the employed sound synthesizer IC modes for the first and second control inputs of message reproducing block 2 are set. At his point, other important preparatory operations also take place. Then message reproducing block 2 goes into the waiting mode (block 29), wherein the power consumption from power supply 4 is minimal.

Message reproducing block 2 goes out of the waiting mode, when an impulse arrives at one of the bits of its second control input.

In case of the event of the first type, that is when the vessel is lifted from the surface, the exit out of the waiting mode takes place in block 30. After this, the code is read from the first control input of message reproducing block 2 (block 31). Then the number of the message for reproduction is determined (block 32) and this message is reproduced (block 33). After this, message reproducing block 2 again goes into the waiting mode (block 34).

In case of the event of the second type, that is when the vessel is put down on the surface, the exit out of the waiting mode takes place in block 35. After this, the code is read from the first control input of message reproducing block 2 (block 36). Then the number of the message for reproduction is determined (block 37), and the selected message is reproduced (block 38). After this, message reproducing block 2 again goes into the waiting mode (block 39).

At each next event, that is when the vessel is lifted from or put back on the surface, blocks 30 . . . 34 or 35 . . . 39 will be accordingly fulfilled. The program terminates when the power is switched off.

The determination of the message number in blocks 32 and 37 is fulfilled depending on the vessel weight. The message content and rules for their selection are set depending of the function of the vessel used with the sound-reproducing support. The rules for selecting messages in blocks 32 and 37 are different. In the result, different messages are reproduced, when the vessel is lifted from the surface and the vessel is put back on it.

The message reproduction subroutine run in blocks 33 and 38 can be done according to well-known rules and operation principle of the sound synthesizer IC employed.

As it is clear from the description of the present invention, the invention provides a sound reproducing support that has advantages over the devices known before. The device according to the present invention is operative to reproduce various audible messages depending on the weight of the vessel placed into it both when the vessel is lifted from the surface and put down on it.

Another advantage of the present invention device is that the possibility to fix the vessel inside the support is provided, so that the support moves along with the vessel when the vessel is lifted from or put down on the surface.

Another advantage of the present invention is the possibility to automatically switch on the power supply when the vessel is inserted in the support, and to automatically switch off the power supply if the vessel is taken out of the support.

### INDUSTRIAL APPLICABILITY

The sound-reproducing supports according to the present invention provide users with a possibility to get information about the vessel weight in a form of audible messages that are easy to perceive. For example, this may be information about the amount of liquid or another substance in a non-transparent vessel. Besides, it is possible to use the device for product promotion or as a souvenir. The sound-reproducing support used with for example a bottle with a drink can reproduce voice messages or music fragments upon each removal of or placing on the table, moreover the content of messages will change depending on the amount of the liquid in the bottle. This will entertain the customer and promote the commercial success of the product, with which the sound-reproducing support according to the present invention is used.

Having described the preferred embodiment of the invention with the reference to the accompanying drawings, it is to be understood that the invention is not limited to this precise embodiment, and that various changes and modifications may be effective therein by one skilled in the art without departing from the scope or spirit of the invention as defined in the appended claims.

We claim:

1. A sound-reproducing support comprising a housing made with a possibility to place a vessel onto it and displaced in said housing a message reproducing block with a loudspeaker, a vessel weight sensor, a coding block, an event detecting block, a switch, and a power supply connected via said switch to said message reproducing block, said vessel weight sensor, said coding block and said event detecting block, wherein an output of said vessel weight sensor is connected through said coding block to a first control input of said message reproducing block, a second control input of which is connected to an output of said event detecting block.

2. The sound-reproducing support of claim 1, with said housing being equipped with an inner overlap serving as a surface for installing a vessel in said housing.

3. The sound-reproducing support of claim 1, wherein said vessel weight sensor is a strain sensor mounted on said housing.

4. The sound-reproducing support of claim 1, wherein said vessel weight sensor comprises a fixed part mechanically connected to said housing and a mobile part connected to said housing via at least one elastic element and mounted so that the weight of a vessel installed into said housing is applied to said mobile part.

5. The sound-reproducing support of claim 1, wherein said coding block further comprises a control input connected to an additional output of said event detecting block.

6. The sound-reproducing support of claim 5, wherein said event detecting block comprises a first, second, and third impulse formers, inputs of said first and third impulse formers being connected to said input of said event detection block, which in its turn is connected to said vessel weight sensor output, an output of said first impulse former being an additional output of said event detecting block and connected via said second impulse former to an output of said event detecting block and to an output of said third impulse former.

7. The sound-reproducing support of claim 5, wherein said event detecting block comprises a switch, a resistor, a first, second and third impulse formers, said switch is operative to unlock upon the placement of said support on the surface and to lock upon the removal of said support from the surface, a first supply input of said event detecting block via switch and second supply input via said resistor are connected to inputs of said first and third impulse formers, an output of said first impulse former being an additional output of said event detecting block and connected via said second impulse former to an output of said event detecting block and to an output of said third impulse former.

8. The sound-reproducing support of claim 1, wherein said housing is implemented with a possibility to fix the vessel installed into it.

9. The sound-reproducing support of claim 8, wherein said housing is further equipped with a fixing ring out of an elastic material.

10. The sound-reproducing support of claim 1, wherein said switch is operative to lock upon the placement of the vessel onto said housing.
